(19) United States
(12) Patent Application Publication
(10) Pub. No.: US 2026/0156308 A1
(43) Pub. Date: Jun. 4, 2026

(54) Method for managing access to content in the process of being streamed

(71) Applicant: Orange, Issy-les-Moulineaux (FR)

(72) Inventors: Olivier GASTE, CHATILLON CEDEX (FR); Hervé MARCHAND, CHATILLON CEDEX (FR)

(21) Appl. No.: 19/358,689

(22) Filed: Oct. 15, 2025

(30) Foreign Application Priority Data
Oct. 15, 2024 (FR) FR2411144

(51) Int. Cl. H04N 21/239; H04N 21/2187; H04N 21/472

(52) U.S. Cl. CPC H04N 21/2396; H04N 21/2187; H04N 21/47217

(57) ABSTRACT

A method for managing access to content in the process of being streamed in the form of successively transmitted chunks of content. A request to access the chunks of content being streamed in real time is followed by chunks of the content being obtained in non-real time.

### CROSS REFERENCE TO RELATED APPLICATION

This application claims priority to and the benefit of French Patent Application No. FR2411144, filed Oct. 15, 2024, the entire content of which is hereby incorporated by reference.

### TECHNICAL FIELD

The field of the present disclosure is that of management of access by a playback device to content being streamed in real time.

The playback device is any data-processing device equipped with a processor and capable of receiving and playing or replaying content being streamed from a content server.

A playback device of this type is for example a set-top box.

The content in question here is multimedia content. It is, for example, televised content. It can be streamed in real time or recorded and streamed in non-real time, i.e. in replay mode. The content can also come for example from a television channel and can relate to a scene being filmed live (*for example by means of a camera, the content being recorded live in this case—this is the case of sporting events for example such as a tennis match, a football match, etc.); the content can also be drawn from a recorded scene.

### PRIOR ART

When multimedia content, such as a film or a filmed event (e.g.: the Olympic Games, a football match, etc.) is accessed, a playback device sends a request to a content server indicating the chosen multimedia (video and/or audio) content. The playback device receives, in return, a digital data stream relating to this content.

The received data are then decoded by the playback device, before being rendered in the form of a display of the corresponding multimedia content.

The content server can transmit content in several ways, namely in multicast mode (for example IPTV, abbreviation of Internet Protocol Television), in unicast mode, etc. After receiving the content, the playback device decodes the content and requests rendering on a rendering device.

HTTP Adaptive Streaming (HAS) allows video to be streamed in OTT mode (OTT being the abbreviation of “Over The Top”), the user being offered the best possible quality given the bandwidth available on the network. This type of streaming is based on an exchange of a manifest file (or simply a “manifest”) between a HAS server and a client playback device. This manifest generally describes (in the form of URLs) the latest video chunks that have been produced. These chunks generally all have the same duration (for example, two seconds).

When a user accesses content, the received chunks are the latest chunks produced on the content server; these latest chunks correspond to the live stream.

The content in question may have started some time ago; the user experience is sub-optimal when the user wishes to start playback at a prior time in the stream, at the start of the content for example.

In addition to playback of content, certain playback devices offer a so-called start-over function that allows a user, for example when they are watching content streamed in real time (a live channel), to replay in non-real time some of the content that has already been streamed; this function in particular allows content to be replayed from a desired time, from its start for example. For example, if a movie streamed in real time starts at 9.00 pm and the user accesses the corresponding live stream by switching to the channel at 9.40 pm, the user may ask, by selecting a command associated with the start-over function, for playback of the content to restart for example from a desired time, 9.15 pm for example, or even from the start of the film, namely 9.00 pm. In this case, a non-real-time replay mode is switched to from a real-time replay mode.

Returning to the start of content therefore requires live content to be received, and a start-over command to be executed in order to return to a prior time, the start of the content for example.

The user experience is once again sub-optimal, in particular when the “rewind” leads to rendering of images that might spoil certain parts of the content.

One or more exemplary aspects of the disclosure aim to improve the situation.

### SUMMARY

To this end, according to one functional aspect, the disclosure relates to a method for managing access to content in the process of being streamed in the form of successively transmitted chunks of content, characterized in that a request to access the chunks of content being streamed in real time is followed by chunks of the content being obtained in non-real time.

According to an exemplary aspect of the disclosure, contrary to the prior art, following reception of access to the live content, the chunks read are not the latest chunks requested but chunks produced beforehand, for example to make it possible to play back the content from its start. Accessing the content from its start therefore requires a simple request to access the content being streamed in real time. In other words, a request to access the chunks of content being streamed in real time is handled as a request to access the chunks in non-real time.

An exemplary aspect of the disclosure has a definite advantageousness in the context of content recorded live such as a sporting event like a football match. In the prior art, a user accessing such content after its start (for example thirty minutes after its start) and wanting to return to the beginning has to activate the start-over mode; during the return to the start (rewind), images are often rendered to illustrate the progress of the rewind; in this case, not only does the rewind take time, but in addition the user is able to see the rendered images and may unexpectedly glimpse scenes of the match; this rewind of the content can have the effect of revealing an event such as a goal.

By virtue of an exemplary aspect of the disclosure, the return to the start is almost instantaneous, a request merely being converted without user intervention; in addition, a user is guaranteed that when the content is played and a rewind executed, for example with a view to playing it from the start, no images are rendered so as not to spoil any relevant content, the rewind taking the least time possible.

It will be noted that an exemplary aspect of the disclosure is implemented either on initial access to a channel or after having switched to a channel.

It will be noted that content in the process of being streamed in the form of chunks concerns chunks streamed successively or groups of chunks streamed successively.

It will be noted here that an exemplary aspect of the disclosure is not limited to a return in the content to the start; a return in the content may concern a return to any previous time between the start time of the content and the current time in the stream.

According to one particular mode of implementation of the disclosure, the content in the process of being streamed has a start time, the replay in non-real time being from the start time. This mode allows, as mentioned above, a return in the content and therefore replay in non-real time of the content without explicit request by the user.

According to another mode, which may be implemented instead of or cumulatively with the preceding one, the content is associated with a type and the method is executed for one type of streamed content. This mode makes it possible not to process every type of content; specifically, not every type of content needs to be played from the start; this mode makes it possible to implement the method only on certain types of content, in particular content resulting from live recording (live program or live stream). This mode avoids unnecessary display on the screen, when the user has not requested or the user does not intend to request the content to be rewound, of an interface (popup) displaying selectable thumbnails requesting selection between whether the streamed content is to be accessed live or in start-over mode.

In other words, for content recorded by a camera live (commonly referred to as live content), such as a football match or a TV news program, gradual rewind is automatically disabled; conversely, for content such as a film, TV series or documentary, and more generally any content not recorded live, gradual rewind is possible; in this case, the user can request gradual rewind with a chosen rewind speed (×4, ×16, ×64, etc.).

This mode of embodiment automates start-over when rewind is required for one type of content in particular. This mode avoids asking the user via an interface/popup about whether or not they wish to rewind.

According to another mode, which may be implemented instead of or cumulatively with the preceding ones, the type of content is content the chunks of which result from live recording. As indicated above, streamed content such as a sporting event that is rewound may be spoiled; this mode allows content to be replayed from its start without spoiling the content.

According to another mode, which may be implemented instead of or cumulatively with the preceding ones, the method comprises rendering a datum informing that the content is being replayed in non-real time. Since the user is unaware that any processing has been carried out, this mode makes it possible to provide a warning that there is an offset with respect to the live (real-time) stream.

According to a first hardware aspect, the disclosure relates to an entity, called the first entity below, for managing access to content in the process of being streamed in the form of successively transmitted chunks of content, characterized in that it comprises a processing module configured to, following a request to access the chunks of content being streamed in real time, obtain chunks of the content in non-real time.

According to another hardware aspect, the disclosure relates to a playback device comprising a management entity as defined above.

According to another hardware aspect, one subject of the disclosure is a computer program capable of being implemented on a management entity as defined above, the program comprising code instructions that, when it is executed by a processor, carries out the steps of the management method that are defined above.

According to another hardware aspect, one subject of the disclosure is a data medium on which at least one series of program code instructions for executing a management method as defined above has been stored.

According to a second functional aspect, the disclosure relates to a method for managing transmission of content in the process of streaming thereof in the form of successively transmitted chunks, characterized in that reception of a request to access the chunks of content being streamed in real time is followed by chunks of the content being transmitted in non-real time.

According to one embodiment related to the second functional aspect, the content being associated with a type, the method is executed for one type of streamed content.

According to another mode related to this second functional aspect, which may be implemented instead of or cumulatively with the preceding one, the type of content is content the chunks of which result from live recording.

According to another mode related to this second functional aspect, which may be implemented instead of or cumulatively with the preceding ones, the method includes a step of transmitting a request to render a datum informing that the content is being replayed in non-real time.

An exemplary aspect of the disclosure also relates to a second entity for managing access to content in the process of being streamed in the form of successively transmitted chunks of content, characterized in that it comprises a processing module configured to, following reception of a request to access the chunks of content being streamed in real time, transmit chunks of the content in non-real time.

An exemplary aspect of the disclosure also relates to a server comprising the second management entity defined above.

An exemplary aspect of the disclosure also relates to a computer program capable of being implemented on the second management entity as defined above, the program comprising code instructions that, when it is executed by a processor, carries out the steps of the method that were defined with reference to the second functional aspect defined above.

An exemplary aspect of the disclosure also relates to a data medium on which at least one series of program code instructions for executing a management method according to the second functional aspect has been stored.

The aforementioned medium may be any entity or device capable of storing the program. For example, a medium may comprise a storage means, such as a ROM (acronym of Read-Only Memory), for example a CD-ROM or a microelectronic circuit ROM, or indeed a magnetic storage means, for example a hard disk. Moreover, an information medium may be a transmissible medium such as an electrical or optical signal, which may be routed via an electrical or optical cable, by radio or by other means. The program according to an exemplary aspect of the disclosure may, in particular, be downloaded over the Internet. As an alternative, the information medium may be an integrated circuit into which the program is incorporated, the circuit being designed to execute or to be used in the execution of the method in question.

### BRIEF DESCRIPTION OF THE DRAWINGS

The disclosure will be better understood on reading the following description, which is given by way of example and with reference to the appended drawings, in which:

FIG. 1 shows a computer system in which an exemplary aspect of the disclosure may be implemented;

FIG. 2 schematically illustrates the hardware structure of a server which is able to transmit manifests;

FIG. 3 schematically illustrates the hardware structure of a playback device which is able to play multimedia streams;

FIG. 4 illustrates one embodiment of the method of an exemplary aspect of the disclosure. This figure is a magnification of a part of FIG. 1 illustrating management of the storage of content in the memory of the server as it is respectively streamed; the entity manages storage of content after it has been streamed in order to allow the content to be replayed in non-real time;

FIG. 5 illustrates an exchange of a message between the playback device and the server during access to content according to a first non-limiting embodiment;

FIG. 6 illustrates an exchange of a message between the playback device and the server during access to content according to a second non-limiting embodiment;

FIG. 7 illustrates an exchange of a message between the playback device and the server during access to content according to a third non-limiting embodiment.

### DETAILED DESCRIPTION OF EMBODIMENTS OF THE DISCLOSURE

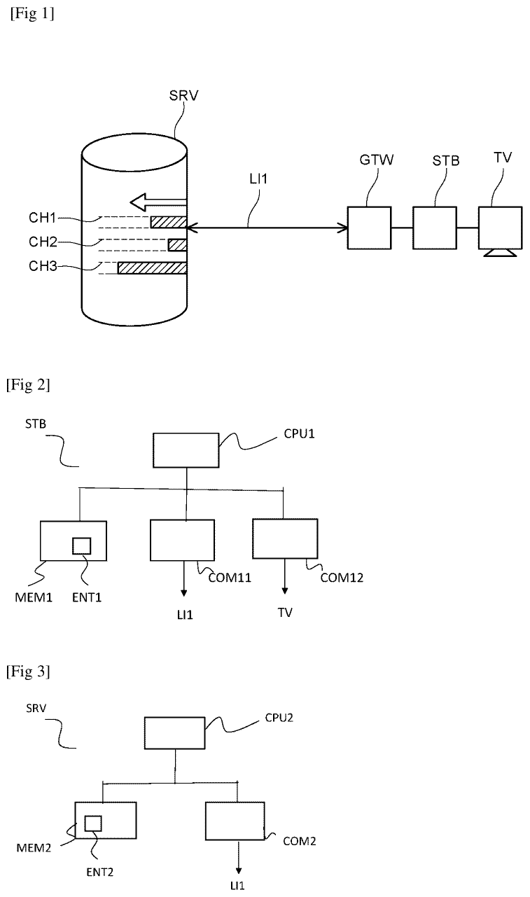

FIG. 1 shows a computer system SYS in which a content delivery network (CDN) is used to transmit content, to client devices or content playback devices, and manifests associated with the multimedia content. The server that streams the content, called the content server in the present text, streams on multiple streaming channels associated with various television channels.

In the present example, for the sake of simplification of the description, the system SYS comprises a single playback device STB. However, the disclosure is applicable to any number of playback devices, the principle of an exemplary aspect of the disclosure being able to be implemented on all or some of the playback devices STB.

The playback device is for example a digital playback device such as a set-top box.

The multimedia content in question here is video content of a television channel. This content is streamed from a server that streams so-called live TV programs, i.e. programs streamed in real time; in other words, images delivered by a camera are encoded into chunks that are made available as soon as they are produced. Access to the latest chunks means that the playback device STB is accessing the streamed content in real time; conversely, access to content other than the latest chunks means that the chunks are being accessed in non-real time.

The streamed content includes content streamed live in real time. This type of content often concerns sporting events such as the Olympic Games. It will be seen below that an exemplary aspect of the disclosure is applicable particularly well to this type of content.

In the present example, the playback device STB is connected to a rendering terminal TV such as a television. The device can transmit data to be rendered to the rendering device TV.

In the present example, the playback device STB is connected to a port of the rendering device TV; the playback device STB and the rendering device TV could also form one and the same device.

In the present example, the playback device STB is located in a local area network LAN managed by a home gateway GTW.

The gateway GTW is able to communicate via a communication link LI1, which may be a telecommunications network such as a wide area network WAN known to those skilled in the art.

In the present example, the computer system SYS employs a content delivery network (CDN) to transmit content to content playback devices STB.

The CDN consists of servers networked in the wide area network; these servers interact in order to make multimedia content available to users. In order to simplify the description of the disclosure, a single content server SRV has been used in FIG. 1 to represent the CDN. The content server SRV is located, in the present example, in the WAN.

The content server SRV for example receives content from digital TV channels distributed by a television broadcaster (not shown) and makes it available to client terminals, and here the playback device STB, in real time via streaming channels. The content can be recorded content or content recorded live by cameras.

FIG. 2 shows an architecture of a playback device STB. This device STB comprises, as is conventional, memories MEM1 associated with a processor CPU1. The memories may be read-only memories (ROMs) or random-access memories (RAMs) or indeed flash memories.

The playback device STB may transmit content to be rendered to the rendering device TV via a communication module COM12. This module COM12 is for example an HDMI link.

The playback device STB communicates with the gateway via an Ethernet module in the case of wired local communication, or via a Wi-Fi radio module in the case of wireless local communication with the home gateway GTW. The module in question is referenced COM11 in FIG. 2.

In the present example, the playback device STB comprises (not shown) a HAS module (HAS standing for HTTP Adaptive Streaming) capable of managing streaming of chunks of the content when the so-called adaptive streaming technique, which is known to those skilled in the art, is used to transmit the content over the network LI1 in chunks.

It will be recalled briefly here that, when a user accesses a live stream delivered via HTTP adaptive streaming (HAS), the playback device STB successively receives, at regular intervals, in general every two seconds, manifests (called real-time manifests below) that generally each describe the last sixty seconds of the stream (30 chunks of 2 seconds) and provide the URL addresses of chunks corresponding to these last sixty seconds. By virtue of the received chunk addresses, the playback device STB is able to download the chunks and play them one after another.

With reference to FIG. 3, the server SRV is also equipped with at least one processor CPU2 and with memories MEM2 for carrying out information processing.

The server SRV communicates with the gateway GTW via a WAN. The server comprises a communication module, referenced COM2, for communicating with the WAN.

Sometimes the start of a television program (movie, series, etc.) streamed in real time is missed, or it is desired to replay content from a given time. A function called “start over” or “restart” makes it possible, at any time, to restart the program in the process of being streamed at a time prior to the current time; for example, playback of the content may be restarted from its start, or from a time chosen by a user. For example, if a movie starts at 9.00 pm and the user switches to the channel at 9.40 pm, they may request for playback of the content to restart from the start of the movie. In this case, playback of the content passes from a real-time (or live) mode to a non-real-time (or replay) mode.

To allow content to be accessed in non-real time, the server SRV stores the segments of content that have been streamed. In the present example, as indicated above, the segments are chunks of content. Chunks that have been streamed are stored in memory MEM2 just after each thereof is streamed.

These segments of content are stored for a certain amount of time. Manifests are created accordingly and include not only the addresses of the most recently produced chunks but also the addresses of the stored chunks; these manifests are then made available to the playback device STB with a view to making it possible for it to access the chunks by downloading them by virtue of the URL addresses included in these manifests.

It will be noted, in the present example, that chunks that have been streamed are stored for a time range preceding the current streaming time.

In one embodiment, time ranges PLn are associated with various streaming channels CHn and the time ranges vary over time. In the present example, the entity will manage the time ranges so as to store only content in the process of being streamed by each of the various streaming channels. Manifests are created accordingly.

In summary, in the present example of embodiment, the time ranges may differ from one channel to another. The disclosure is not limited to this use case, the time ranges could be identical for all the streaming channels and independent of the start time of the content in question on a given channel.

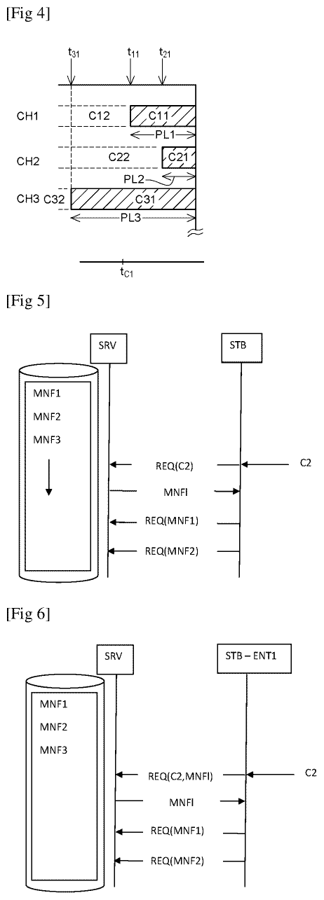

FIG. 4 schematically illustrates, in the server SRV, a list of content of streaming channels of respective TV channels CH1-CH3.

Time ranges PLn (n corresponds to one channel CHn, n being an integer) have also been shown in association with each streaming channel. The time ranges precede the current streaming time tc by a certain amount of time. As explained above, each range is managed in such a way that the chosen amount of time is such that the channels store only content in the process of being streamed from its start. It will be noted that this is only one embodiment; other embodiments can be imagined in which the time range remains constant and therefore independent of the start time of the content in the process of being streamed.

Specific manifests are used to access the chunks. Indeed, a request to access chunks can be made in various ways depending on whether the manifests are manifests:
including a description solely of the latest chunks (called the “short manifest” below);
or including not only the latest chunks but also chunks over a given time range as explained above (called the “long manifest” below); this type of manifest makes it possible to rewind the content in order to replay it in non-real time.

FIG. 4 shows a state of the storage of the content at a first time tc.

At this given current time tc, called the current time, the channels are respectively in the process of streaming content C1, C2, C3 in real time, namely:
first content C1 that began to stream at the time t1;
second content C2 that began to stream at the time t2;
third content C3 that began to stream at the time t3.

Assume now that a user wishes to play the content C2 streamed in real time live. To do so, in the present example, this user selects the second channel CH2.

A management entity is capable of receiving a request to access the chunks of multimedia content C2 in the process of being streamed and of obtaining, following reception of the request, chunks of the same content in non-real time.

According to an exemplary aspect of the disclosure, reception of a request to access the streamed content in real time is handled as a request for access in non-real time.

It will be seen below in the following embodiments that the management entity handles a request to access the content in real time as a request to access the content in non-real time.

The location of the management entity ENT is immaterial; it may be located in the playback device STB, in the server SRV, or elsewhere in the network. When the conversion is carried out in the playback device STB, the entity is referenced ENT1. When the conversion is carried out in the server, the entity is referenced ENT2. Below, the entity is assumed to be installed in the playback device STB.

In other words, although having received a request to access the chunks being streamed in real time, the playback device STB receives older chunks from the server SRV; the content is thus replayed in non-real time.

With reference to FIG. 5, an embodiment in which the access request is converted into a request to access the content from its start will now be described. The disclosure is of course not limited to this embodiment; the replay in non-real time being from any point.

FIG. 5 comprises axes associated with the server SRV and with the playback device STB.

In this embodiment, the entity ENT1 is assumed to be located in the playback device STB. It is also assumed that the playback device STB periodically receives long manifests described above, so as to be able to replay content in non-real time.

The steps are as follows.

It is assumed that chunks of content are produced in real time on the server SRV, and that they are made available once each is produced.

Following production of chunks of the content C2 by the server, long manifests MNF1-MNF4 are created and successively transmitted in response to requests made by playback devices. The first manifest MNF1 produced is the first manifest created; this manifest describes the first chunks of the relevant content corresponding to the start of the content (typically the start of a television program); the second manifest MNF2 describes the following chunks; and so on.

In a first step, the management entity ENT1 receives a request to access the content C2 from a control interface.

In a following step, the playback device STB transmits a request REQ (C2) to access the content to the server SRV.

Next, the playback device STB receives in return a long manifest describing the URLs of the chunks present in the range PL2 described above.

In a subsequent step, in order to obtain chunks in non-real time, the management entity ENT1 converts the request to access the content C2 into a request for access in non-real time; to do this, the management entity ENT1 requests access to the first and subsequent chunks of the content using the long manifest received.

In a subsequent step, the playback device STB successively receives the first and subsequent chunks and renders them.

This embodiment clearly shows that a request to access chunks in real time is handled as a request to access content in non-real time.

FIG. 6 illustrates another embodiment in which the received manifests are short manifests.

In a first step, the management entity receives a request to access the content C2 from a control interface.

In a following step, the playback device STB transmits a request REQ (C2, MNFI) to access the content including as parameter an identifier of the content C2 and a request to receive a long manifest MNFI so as to be able to replay the content in non-real time.

In a subsequent step, the playback device STB receives in return a long manifest describing the URLs of the chunks present in the range PL2 described above.

In a following step, the management entity ENT1 requests access to the content C2 in non-real time.

In summary, the initial request received by the entity, requesting access to the stream being streamed in real time, is converted into a request to access the content C2 in non-real time.

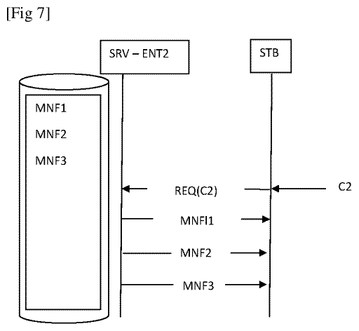

Another embodiment will be described with reference to FIG. 7. In this embodiment, as in the embodiment described with reference to FIG. 5, the playback device STB receives short manifests describing the latest chunks of content produced.

Unlike the embodiment of FIG. 5, following transmission of a request to access the content C2, the server SRV receives the request and transmits in return manifests successively created since the start of the streaming of the content C2. The playback device STB then receives the first manifest MNF1, the second manifest MNF2, and so on. The playback device STB is able to replay the content in non-real time.

In this embodiment, the server SRV takes the initiative of transmitting the manifests required for replay in non-real time. The conversion therefore takes place in the server SRV. In this embodiment, the playback device STB is therefore relieved of some of the processing related to the conversion of a request to access the stream delivered in real time into a request to access the content in non-real time.

More generally, the method managed by the second entity ENT2 is characterized in that reception of a request (REQ (C2); REQ (C2, MNFI)) to access the chunks of content being streamed in real time is followed by chunks of the content being transmitted in non-real time.

The embodiments described above may be implemented on their own or in combination.

The embodiments described above may have variants.

According to one variant, conversion of the initial playback request into a request for replay in non-real time causes a datum informing that the content is being played back in non-real time to be rendered. Specifically, since the initial request regarded playback of the content in real time, it is necessary to inform the user that the chunks being transmitted and rendered are chunks that have already been streamed.

According to another variant, after the content has been rendered in non-real time, a command to return to the live stream is provided in order to make it possible to return to content being streamed in real time. This command is accessible from the screen on which the content is being rendered. The stream being delivered in real time may therefore be returned to very rapidly by selecting the command to play the live stream directly on the screen.

According to another variant, the conversion referred to above is executed only for one type of content such as, for example, content that is being recorded live; this is the case for sporting events, a speech by a president, etc. In this case, it is often advantageous to see the content in question from its start as quickly as possible and without running the risk of rewinding spoiling the content.

It will also lastly be noted here that the term “entity” may correspond either to a software component or to a hardware component or to a set of hardware and software components, a software component itself corresponding to one or more computer programs or subprograms or, more generally, to any element of a program which is able to implement a function or a set of functions as described for the modules concerned. In the same way, a hardware component corresponds to any element of a hardware assembly which is able to implement a function or a set of functions for the module concerned (integrated circuit, chip card, memory card, etc.)

Although the present disclosure has been described with reference to one or more examples, workers skilled in the art will recognize that changes may be made in form and detail without departing from the scope of the disclosure and/or the appended claims.

1. A management method implemented by an entity device and comprising:
managing access to content in the process of being streamed in the form of successively transmitted chunks of content, comprising:
transmitting a request to access the chunks of content being streamed in real time, followed by obtaining chunks of the content in non-real time.

2. The management method according to claim 1, further comprising replaying the obtained chunks of the content in non-real time, wherein the content in the process of being streamed has a start time, the replay in non-real time being from the start time.

3. The management method according to claim 1, wherein the content is associated with a type and the method is executed for one type of streamed content.

4. The management method according to claim 3, wherein the type of content is content the chunks of which result from live recording.

5. The management method according to claim 4, wherein the method comprises rendering a datum informing that the content is being replayed in non-real time.

6. A management entity device comprising:
at least one processor; and
at least one non-transitory computer readable medium comprising instructions stored thereon which when executed by the at least one processor configure the management entity device to manage access to content in the process of being streamed in the form of successively transmitted chunks of content, by:
transmitting a request to access the chunks of content being streamed in real time, followed by obtaining chunks of the content in non-real time.

7. A playback device comprising the management entity device as defined in claim 6.

8. A non-transitory computer readable data medium comprising at least one series of program code instructions stored thereon, which when executed by at least one processor of the management entity device configure the management entity device to execute the method according to claim 1.

9. A management method implemented by a management entity device and comprising:
managing transmission of content in the process of being streamed in the form of successively transmitted chunks, the managing comprising:
receiving a request to access the chunks of content being streamed in real time, followed by transmitting the chunks of the content in non-real time.

10. The management method according to claim 9, wherein the content is associated with a type and the method is executed for one type of streamed content.

11. The management method according to claim 10, wherein the type of content is content the chunks of which result from live recording.

12. The management method according to claim 9, wherein the method comprises transmitting a request to render a datum informing that the content is being replayed in non-real time.

13. A management entity device comprising:
at least one processor; and
at least one non-transitory computer readable medium comprising instructions stored thereon which when executed by the at least one processor configure the management entity device to manage access to content in the process of being streamed in the form of successively transmitted chunks of content, wherein the managing comprises:
receiving a request to access the chunks of content being streamed in real time, followed by transmitting the chunks of the content in non-real time.

14. A server comprising the management entity device as defined in claim 13.

15. A non-transitory computer readable data medium comprising at least one series of program code instructions stored thereon, which when executed by at least one processor of the management entity device configure the management entity device to execute the method according to claim 9.
